(19) United States
(12) Patent Application Publication
(10) Pub. No.: US 2006/0109485 A1
(43) Pub. Date: May 25, 2006

(54) Measuring the diameter of rod-shaped articles of the tobacco-processing industry

(75) Inventor: Max Laemmel, Schwarzenbek (DE)

Correspondence Address: GREENBLUM & BERNSTEIN, P.L.C., 1950 ROLAND CLARKE PLACE, RESTON, VA, 20191, US

(73) Assignee: HAUNI MASCHINENBAU AG, Hamburg (DE)

(21) Appl. No.: 11/280,246

(22) Filed: Nov. 17, 2005

(30) Foreign Application Priority Data
Nov. 25, 2004 (DE) 10 2004 057 092.2

(51) Int. Cl. G01B 11/02

(52) U.S. Cl. 356/635

(57) ABSTRACT

Device and machine for determining the diameter and/or the cross-sectional shape of rod-shaped articles of the tobacco-processing industry. Several, in particular more than three, light sources for emitting in particular linear light to the article and respectively one sensor for each light source for receiving light scattered from the article surface are provided and that an evaluating unit is provided for evaluating the measurement signals of the sensors.

### CROSS-REFERENCE TO RELATED APPLICATIONS

The present application claims priority under 35 U.S.C. §119 of German Patent Application No. 10 2004 057 092.2, filed on Nov. 25, 2004, the disclosure of which is expressly incorporated by reference herein in its entirety.

### BACKGROUND OF THE INVENTION

1. Field of the Invention

The invention relates to a device for determining the diameter and/or the cross-sectional shape of rod-shaped articles of the tobacco-processing industry. Furthermore, the invention relates to a machine of the tobacco-processing industry, in particular a cigarette-making machine or a filter tipping machine.

In the present connection, “rod-shaped objects of the tobacco-processing industry” here denote cigarettes, filter rods, filter cigarettes and similar objects of predetermined diameter. The present invention deals primarily with the diameter measurement of rod-shaped articles, such as endless rods and, in particular, filter rods, which are conveyed continuously. When only rod-shaped articles are referred to below for the sake of simplicity, rod-shaped articles of the above-mentioned type should at any rate not be excluded, irrespective of the then production stage of these objects. Furthermore, the term “rod-shaped object” also covers an endless rod that is present in a specific production stage as a whole or as an already severed rod piece, for example for producing the above-mentioned smokers' articles.

2. Discussion of Background Information

In the production of cigarettes and filters, the diameter is an essential quality feature which has to be monitored during production. The rod-shaped objects are thereby usually conveyed continuously or discontinuously through a measuring arrangement in the longitudinal direction, thus in the direction of their longitudinal axis. The difficulty of precise measurements of the diameter lies in that the rod-shaped articles are often out-of-round, thus the cross sections perpendicular to the longitudinal axes deviate more or less from the circular shape.

In the manufacture of articles produced in the rod methods such as, e.g., filter rods, the variations in diameter should be kept as slight as possible. Deviations in the diameter of a filter rod are particularly unfavorable because with mouthpiece cigarettes assembled from filter plugs and cigarettes, plugs and cigarettes have to have the same diameter so that connecting them, e.g., by a connection sheet can take place without gaps remaining between the sheet and the plug or cigarette through which secondary air could penetrate and impair the smoking properties.

A device for measuring the diameter of filter rods by a pneumatic testing system is known from DE 34 14 247 A1 (corresponds to U.S. Pat. No. 4,543,816).

Furthermore, a measuring device for measuring the diameter of a rod-shaped object of the tobacco-processing Industry is described In EP 1 445 576 A1, whereby the rod-shaped article is measured by a light section. In order to obtain sufficient diameter points, the laser light source has to be swiveled around the rod-shaped article.

### SUMMARY OF THE INVENTION

On the basis of this prior art, the present invention measures simply and quickly the diameter of rod-shaped articles of the tobacco-processing industry.

The invention is directed to a device for determining the diameter and/or the cross-sectional shape of rod-shaped particles of the tobacco-processing industry. The device includes several, in particular more than three, light sources for emitting in particular linear light to the article and respectively one sensor for each light source for receiving light scattered from the article surface and an evaluating unit for evaluating the measurement signals of the sensors.

The invention is based on the concept that the rod-shaped article is illuminated by all the light sources at one point at the same time so that light is scattered from the surface of the article at the illuminated point and the scattered light is detected by sensors. One sensor is hereby respectively assigned to one light source so that the profile of a partial surface of the entire circumferential surface of the article illuminated by a light source is determined by one sensor. In order to be able to determine the diameter at a predetermined point of the article at the same time and without shade areas, it is necessary for several light sources to illuminate the article at this point. A rapid and reliable determination of the diameter of the article is thus ensured. Furthermore, several light sources are necessary in order to cover the article completely, i.e., without shading or the like.

According to an expedient embodiment, it is proposed that the light sources are arranged and/or embodied such that the article in its circumference, preferably at a predetermined point, is essentially completely covered.

Furthermore, it is advantageous if the sensors are embodied to detect a height profile of the article.

To this end it is provided that the sensors are respectively embodied as position-sensitive detectors, in particular as so-called PSD arrays. Position-sensitive detectors or sensors are known under the term “PSD” which, in addition to having a simple construction, also work very reliably. Moreover, position-sensitive detectors are characterized by low measurement tolerances and short measurement times. Such sensors are often used as distance sensors which work according to the triangulation principle. A well collimated analysis beam, e.g., a laser beam, is hereby transmitted to a sample surface so that the scattered light reaches the position-sensitive detector (PSD) from the illuminated surface via an optical system. The location of the occurring scattered light depends on the distance to the object surface. The position-sensitive detectors can clearly convert the coordinates of the light spot on the detector into electric signals so that the distance from the measured object can be determined quickly and precisely.

In order to be able to determine a height profile of an object easily and quickly, so called PSD arrays are used so that an entire height profile line is determined in a single measuring operation.

To this end, it is advantageously provided that the light sources emit the right in a linear manner so that the height profile of the article partially illuminated by the light source is scattered at a predetermined point and determined by a PSD array.

A improved arrangement results if the emitted light beams of the light sources lie in one plane. Such a plane is formed, e.g., by a perpendicular plane to the longitudinal axis of the article.

Furthermore, it is favorable if the light sources and/or the sensors are arranged around the article in a star-shaped manner, in particular uniformly and/or symmetrically.

Moreover, it is preferred if the evaluating unit ascertains the shape and/or the dimension of the diameter of the rod-shaped article.

Furthermore, the invention provides a machine of the tobacco processing industry, in particular a cigarette-making machine or a filter tipping machine which is equipped with a device according to the invention and described above. To avoid repetitions, reference is expressly made to the above statements.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein;

FIG. 1 diagrammatically illustrates an arrangement for determining a height profile of a partially illuminated smokers' article rod;

FIG. 2 illustrates a further arrangement with a detailed representation of a PSD array; and

FIG. 3 illustrates a measuring arrangement for measuring a diameter of a smokers' article rod.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

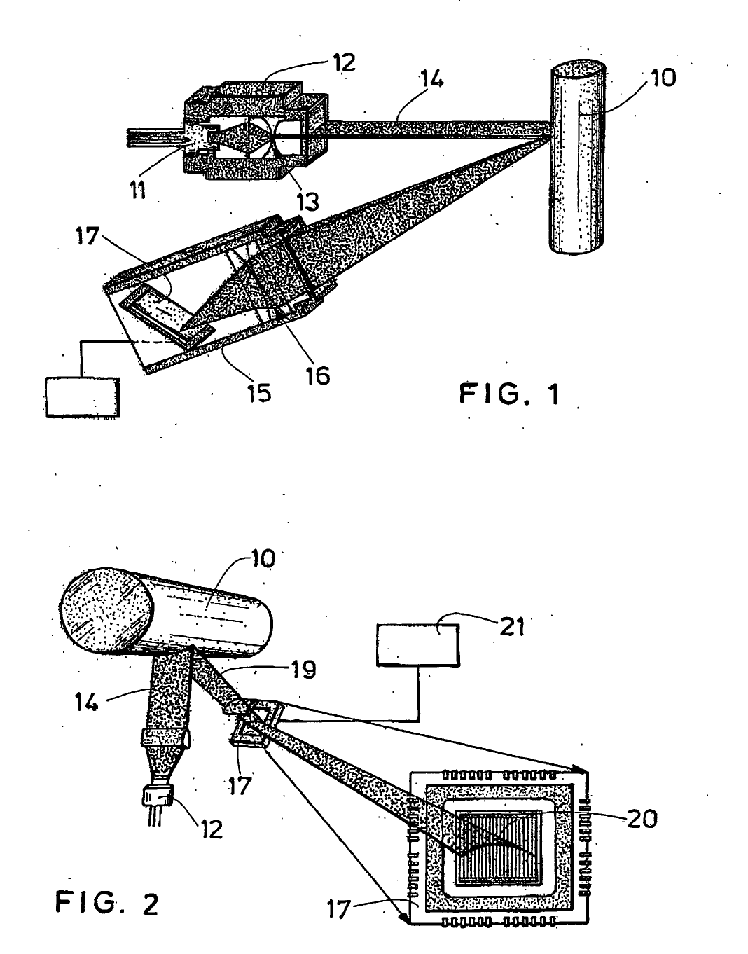

FIG. 1 shows diagrammatically an optical arrangement for measuring a partial profile of the diameter of a rod-shaped smokers' article 10. The smokers' article 10 can be at rest as well as moved, i.e., conveyed, during the measurement. A collimated light beam 14 with a predetermined width is emitted to the smokers' article 10 by an emitter 12 with a laser diode 11 and a cylinder optical system 13.

The light scattered on the illuminated point of the smokers' article 10 is received in an angular range by a receiver 15 which is embodied with an imaging optical system 18 and a position-sensitive detector array (PSD array). The profile of the partial surface of the smokers' article 10 determined by the light beam 14 is determined as a height profile by the PSD array 17. The PSD array 17 is connected via a connection to an evaluating unit 21, whereby the roundness or out-of-roundness of the illuminated partial area of the smokers' article 10 is detected.

FIG. 2 shows from another perspective view the determination of the profile of the partially illuminated surfaces of the smokers' article 10. A collimated light beam 14 is transmitted to the surface of the smokers' article rod 10 by the light emitter 12. From there the scattered light (reference number 19) reaches the PSD array 17.

The PSD array 17 is shown diagrammatically enlarged in the lower right of FIG. 2, whereby a height profile 20 is registered at the illuminated point in accordance with the shape of the smokers' article 10. The sites of the impinging scattered light depend on the distance from the round smokers' article rod 10. Through this the distance to the rod can be determined quickly and precisely.

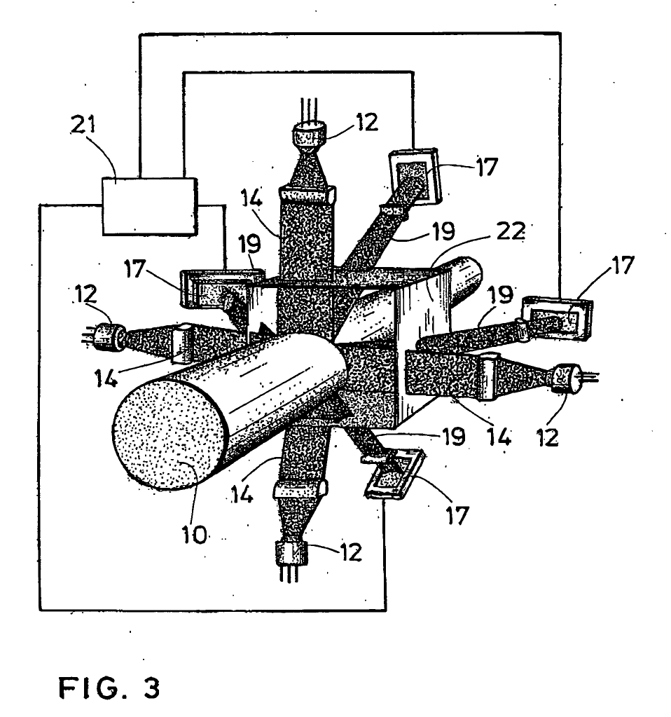

FIG. 3 shows in diagrammatic form a device for determining or measuring the diameter of the rod-shaped smokers' article 10. The smokers' article 10 is conveyed through a glass body 22 with four walls in a lengthwise axial manner. Four emitters 12 are arranged around the glass body 22 or the smokers' article 10 in a star-shaped or cross-shaped manner to produce collimated light, whereby the emitted light beams 14 lie in a perpendicular plane to the longitudinal axis or to the conveyor direction of the smokers' article 10.

The emitted light beams 14 impinge on the surface of the article 10 so that one quadrant of the smokers' article 10 is illuminated by respectively one light beam 14. PSD arrays 17 for registering the scattered light are arranged in the respective quadrant for each of the light sources 12, so that a precise profile of the surface of the smokers' article 10 is detected by the evaluating unit 21. On the basis of the measurement result, a rapid and precise diameter measurement of the smokers' article can take place, whereby the diameter is determined at a predetermined point. Moreover, in addition to the measurement of the diameter, the shape of the rod and also an adhesive-coated seam of a wrapping strip on the smokers' article rod can also be checked with this arrangement.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE NUMBERS

| | |
|---|---|
| 10 | Smokers' articles |
| 11 | Laser diode |
| 12 | Emitter |
| 13 | Cylinder optical system |
| 14 | Light beam |
| 15 | Receiver |
| 16 | Imaging optical system |
| 17 | PSD array |
| 19 | Scattered light |
| 20 | Height profile |
| 21 | Evaluating unit |
| 22 | Glass body |

What is claimed:

1. A device for determining the diameter and/or the cross-sectional shape of rod-shaped articles of the tobacco processing industry, wherein several, in particular more than three, light sources for emitting in particular linear light to the article and that respectively one sensor for each light source for receiving light scattered from the article surface are provided and that an evaluating unit is provided for evaluating the measurement signals of the sensors.

2. A device according to claim 1, wherein the light sources are arranged and/or embodied such that the article is covered essentially completely in Its circumference.

3. A device according to claim 1, wherein the sensors are embodied for determining a height profile of the article.

4. A device according to claim 3, wherein the sensors are embodied respectively as position-sensitive sensors, in particular as so-called PSD arrays.

5. A device according to claim 1, wherein the light sources emit the light in a linear manner.

6. A device according to claim 1, wherein the emitted light beams lie in one plane.

7. A device according to claim 1, wherein the light sources are embodied as laser light sources.

8. A device according to claim 1, wherein the light sources and/or the sensors are arranged around the article in a star-shaped manner, in particular uniformly and/or symmetrically.

9. A device according to claim 1, wherein the evaluating unit determines the shape and/or the dimension of the diameter of the article.

10. A machine of the tobacco-processing industry, in particular an endless rod-maker or a filter tipping machine, with a device according to claim 1.
